(19) United States
(12) Patent Application Publication
(10) Pub. No.: US 2006/0033221 A1
(43) Pub. Date: Feb. 16, 2006

(54) Ceramic scent vapor device specification sheet

(76) Inventor: Meng-Ji Lin, Sanchong City (TW)

Correspondence Address: BIRCH STEWART KOLASCH & BIRCH, PO BOX 747, FALLS CHURCH, VA, 22040-0747, US

(21) Appl. No.: 10/917,497

(22) Filed: Aug. 13, 2004

(51) Int. Cl. B01F 3/04

(52) U.S. Cl. 261/30; 261/104; 261/DIG. 88

(57) ABSTRACT

A device of ceramic scent vapor, arranged at outlet, such as air conditioner, fans, etc. to spread essence oil on the ceramic scent vapor, which possess multiple vents. Among which ceramic piece built in by blending with the characteristics of mixing various kinds of ceramic clay, and heat up ceramic plate instead of porcelainize by adequate thermo control so that tiny vent can be built in the inner side of the ceramic plate to possess the ability of absorbing large amount of essence oil and spread reciprocally thereafter. Owned multiple airholes on surface of ceramic plate have superior in enlarge widely and filing scent speed up work.

### CONCEPT OF THE INVENTION

Initial invention originated from device of Ceramic Scent Vapor under safety without pollution regulation, and enjoys aromatherapy wholly at the same time.

Especially refer to unique device of inside ceramic plate which can be used widely match with ventilation tools, as put in front of air conditioner or fan's outlet to disperse the essence. Ceramic plate has multiple holes with ceramic feature enable keep scent in long time.

### BACKGROUND OF THE INVENTION

A conventional scent vapor as shown in FIG. 1, put in the outlet of air conditioner, fans, etc. usually made of cotton and paper material which is inefficient in absorbing essence oil into scent plate, and spread the tiny fragrance all over the corner by the air flow at the outlet. The over usage scent plate will not meet the minimum requirement because of the fiber fatigue or inefficient absorbing capability caused by long term use in absorbing essence oil. Therefore the efficiency of scent plate built in such kind of materials is not ideal in the reason of uneven airhole gap, which cause unsteady air flow that influence the spread efficiency. Accordingly, scent plate in these kinds of materials will become soft, inflated, and yellowish after airholes processing of absorbing essence oil, and cause inconvenient to fit on. It would be desirable to find the way to improve this from occurring.

### SUMMARY OF THE INVENTION

Primary motive of the present invention is provide one device of ceramic scent vapor equipment to spread essence into area, depend on character of air flow complete vaporing essential oil function in short time.

Next object of the present invention to make essential oil fill into ceramic plate fast and evenly.

The objects of this invention have been obtained by providing a device of ceramic scent vapor primary blend the characteristics of numerous kinds of ceramic clay, and by adequate thermo control burn scent ceramic piece into piece structure before porcelainize, so that large quantity of small vents could be generated in the inner side, and therefore possess the ability of absorbing big amount of essence oil and spread scent on a reciprocal use base, and multiple airholes set up on the surface. Futhermore, oil conductive groove pick across the gap of airholes, and look like half round curve from lateral perspective view.

According to the structure mentioned above, in the inner side of the ceramic piece has a large quantity of small vents which increase the absorbing space of essence oil, and the quality of ceramic piece is hard and will not become soft and assembly problem during the period of processing multiple airholes. On the other hand, the shape of airhole can be altered to square, round, and other irregular types, etc. Not only increase the scent spread area and speed the air flow, but also have the good looking appearance; further, oil conductive groove pick across the gap of airholes, and lead the essence oil into the ceramic pieces fast and evenly absorb by the vents.

### DETAILED DESCRIPTION OF THE PREFERRED EMBODIMENTS

Embodiments of the present invention will be described herein below by reference to the accompanying drawings and an adequate practical example:

Referring to FIG. 2 2A, the present invention ceramic scent vapor is make use of the characteristics of various kinds of ceramic clay, and burn scent ceramic piece into piece structure before porcelainize, its shape could be round, square, triangle, or irregular so that small vents 2 could be generated in a large amount in the inner side, and possessed the ability of absorbing essence oil and spread scent on a reciprocal use base, and several airholes 3 designed on the surface.

Referring to FIG. 3, 3A, at one side of ceramic scent vapor creates the edge of air hole 3 into funnel type structure. Not only enlarge the disperse area, but also make more convenient for the airflow.

Referring to FIG. 4, 4A, oil conductive groove 4 pick across the gap of airholes 3, and look like half curve from lateral perspective view.

Referring to FIG. 5, the present invention, ceramic scent vapor 1, arranged on the outlet of air flow, and fixed the ceramic scent vapor 1 on outlet by clipping with a clamp 5. The scent fragrance disperse when air flow through the ceramic scent vapor 1.

Referring to FIG. 6, shows the state of the practical implementation of the invention made into a box 6 which is fixed an active carbon plate 6a on the back to filter the inflow air, and a fan 6b and small bulb 6c fixed in front of the active carbon plate 6a, and in front of both sides of the box 6 set up multiple slots 6d which is used to put ceramic scent vapor 1; furthermore, fill essence oil onto the ceramic scent vapor 1 and insert into slots 6d altering absorbing the essence oil completely that will vapor quickly by the heat of the bulb and spread allover. Different slots can insert different flavors of ceramic scent vapor 1, and enjoy different smelling simultaneously.

Referring to FIG. 7, shown another state of the practical implementation of the invention, put an spring or hard rubber 7 onto a solid base 7a, and fixed ceramic scent vapor 1 on top of the spring or rubber 7, the device of which arranged in the automobile will spread flavor in the car, while the car is driving the spring or rubber will vibrate with the ceramic scent vapor.

Focused on changes and modifications in the above-described embodiments of the invention can style, of course, be carried out without departing from the scope thereof. Accordingly, to promote the progress in science and the valued arts, the invention is disclose and is intended to be limited only by the scope of the appended claim.

These and other objects, features, and advantages of the present invention will become more apparent upon reading the following specification in conjunction with accompany drawing figures.

### STRUCTURE DRAWING AND BRIEF

FIG. 1 a conventional drawing

FIG. 2 top plan view of the invention

FIG. 2A partial cross-sectional view of the invention

FIG. 2 the top plan view of the invention

FIG. 3A a partial cross-sectional view of the invention

FIG. 4 top plan view of the invention

FIG. 4A a partial cross-sectional view of the invention

FIG. 5 an illustration of ceramic scent vapor fixed on the outlet

FIG. 6 a practical implementation of the present invention

FIG. 7 another practical implementation of the present invention

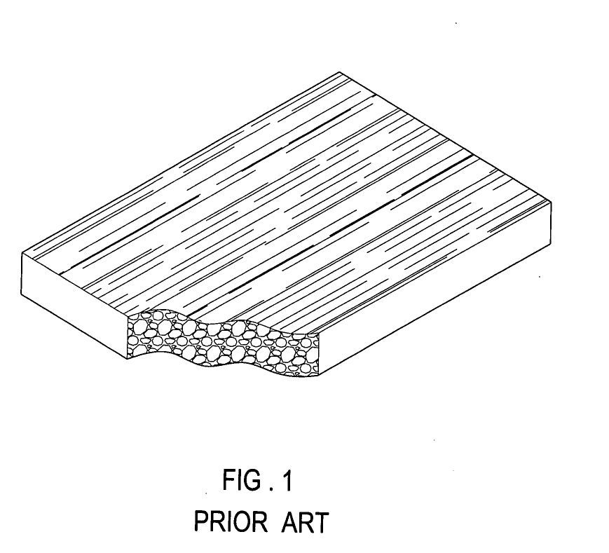

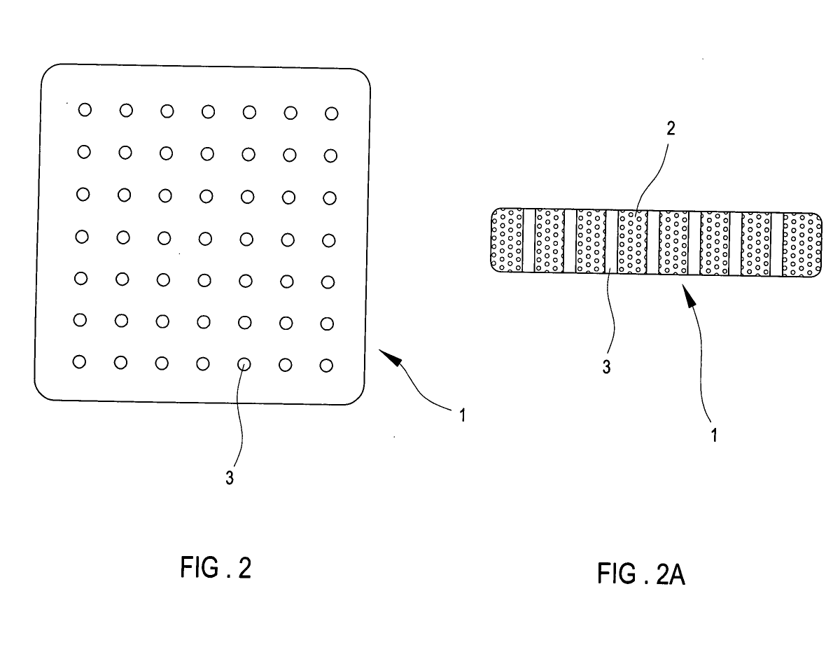

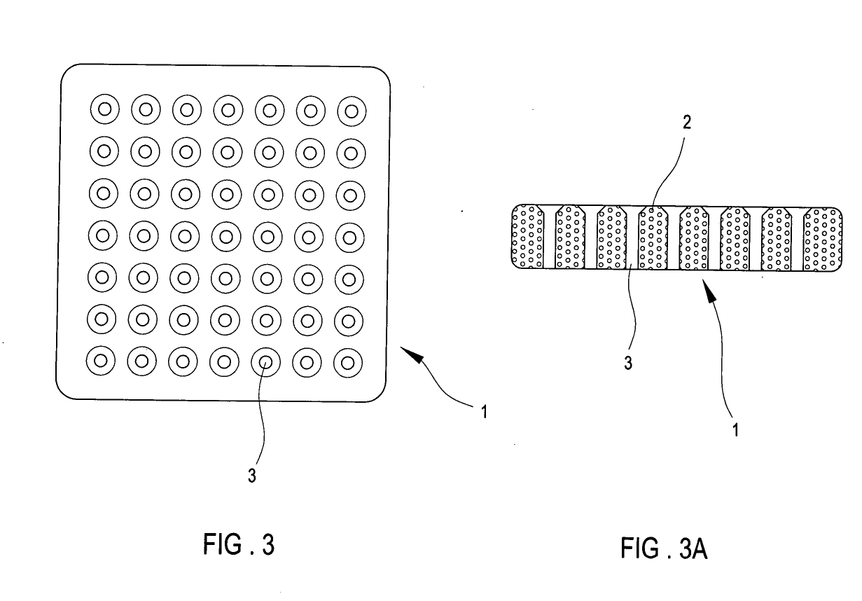

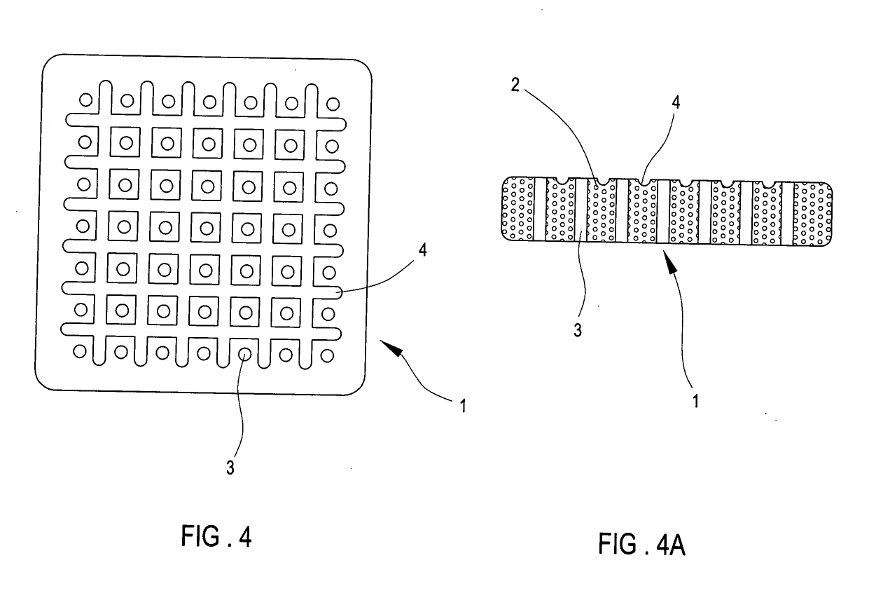

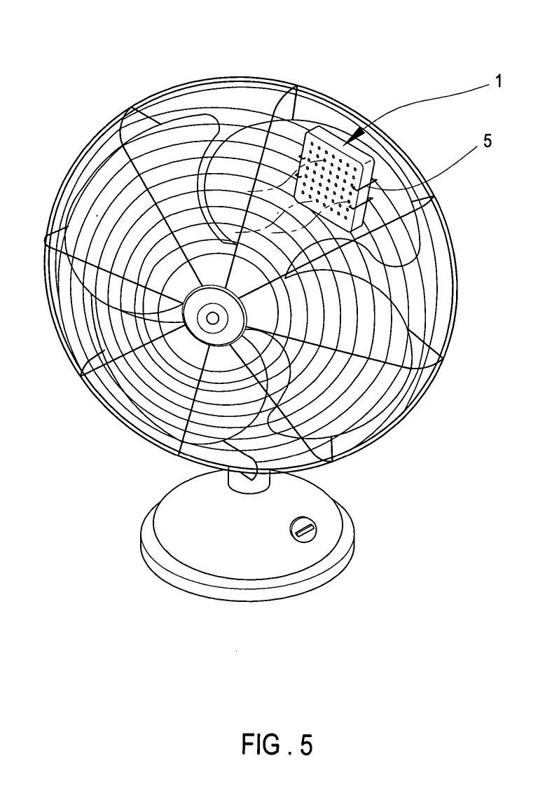

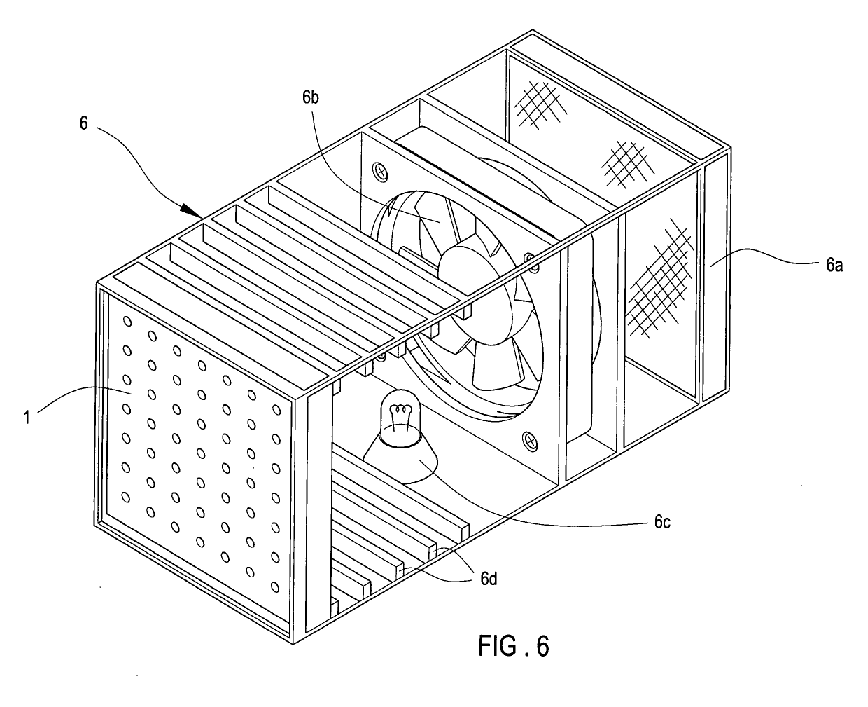

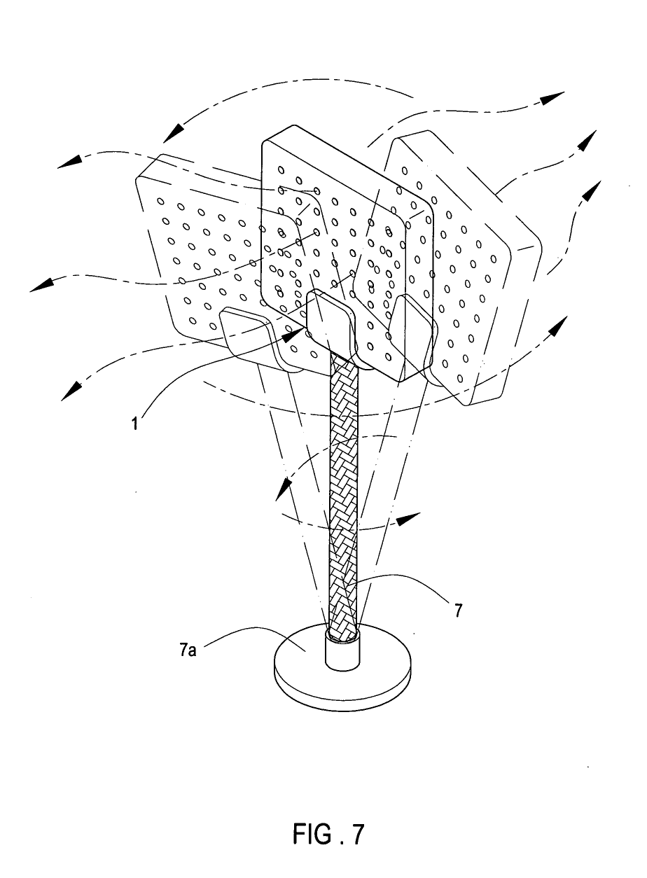

| | | | |
|---|---|---|---|
| 1 | ceramic scent vapor | 2 | vent |
| 3 | airhole | 4 | conductive groove |
| 5 | clamp | 6 | box |
| 6a | active carbon | 6b | fan |
| 6c | bulb | 6d | slot |
| 7 | spring or hard rubber | 7a | solid base |

1. Device of “ceramic scent vapor”, the ceramic plate of which is blending with the characteristics of various ceramic clay, and by thermo control burn scent into ceramic plate structure before porcelainize; a large amount of vents in the inner side, and several airholes arranged on the surface so that essence oil can fill in.

2. The ceramic scent vapor according to claim 1, wherein at one side of ceramic scent vapor creates the edge of air hole into funnel type structure.

3. The ceramic scent vapor according claim 1, wherein oil conductive groove pick across the gap of airholes, and look like half curve from lateral perspective view.
